(19) United States
(12) Patent Application Publication
(10) Pub. No.: US 2022/0180747 A1
(43) Pub. Date: Jun. 9, 2022

(54) PARKING ASSIST SYSTEM

(71) Applicant: DENSO CORPORATION, Kariya-city (JP)

(72) Inventors: Takamasa HIDAKA, Kariya-city (JP); Koudai YAMAURA, Kariya-city (JP)

(21) Appl. No.: 17/678,326

(22) Filed: Feb. 23, 2022

Related U.S. Application Data
(63) Continuation of application No. PCT/JP2020/030702, filed on Aug. 12, 2020.

(30) Foreign Application Priority Data
Aug. 27, 2019 (JP) 2019-154563

(51) Int. Cl. G08G 1/14; B60W 30/06; B60W 60/00; B60W 50/02; B60P 3/07; G06Q 50/30

(52) U.S. Cl. CPC G08G 1/148; B60W 30/06; G06Q 50/30; B60W 50/0205; B60P 3/07; B60W 60/00256

(57) ABSTRACT

A parking assist system includes: a self-driving vehicle, an unmanned carrying vehicle, and a management device. The self-driving vehicle includes a status transmitting unit that transmits, to the management device, a vehicle status and a position transmitting unit that repeatedly transmits position information indicative a position of the self-driving vehicle to the management device. The management device includes: an abnormality determination unit that determines whether an abnormality occurs in the self-driving vehicle based on the vehicle status; a driving settings unit that transmits, to the unmanned carrying vehicle, a transport instruction for the unmanned carrying vehicle to transport the self-driving vehicle when an abnormality occurs and transmits, to the self-driving vehicle, an self-driving instruction for the self-driving vehicle to move by self-driving when an abnormality does not occur.

### CROSS REFERENCE TO RELATED APPLICATIONS

This application is a continuation application of International Patent Application No. PCT/JP2020/030702 filed on Aug. 12, 2020, which designated the U.S. and claims the benefit of priority from Japanese Patent Application No. 2019-154563 filed on Aug. 27, 2019. The entire disclosure of all of the above application is incorporated herein by reference.

### TECHNICAL FIELD

The present disclosure relates to a parking assist device configured to assist a user to park a vehicle.

### BACKGROUND

There has been known an auto-parking system where a vehicle is transported to a parking position using an unmanned carrying vehicle if the vehicle has no self-driving functionality and a vehicle moves to a parking position if the vehicle has a self-driving functionality.

### SUMMARY

According to one aspect of the present disclosure, a parking assist system is configured to assist for a vehicle to park. The parking assist system includes: a self-driving vehicle configured to perform self-driving from a boarding/alighting area to a parking position in a parking lot; an unmanned carrying vehicle that is configured to transport a vehicle in the parking lot; and a management device that is configured to move the self-driving vehicle by the unmanned carrying vehicle between the parking position and the boarding/alighting area by controlling the unmanned carrying vehicle and the self-driving vehicle. The self-driving vehicle includes: a status transmitting unit that is configured to transmit, to the management device, a vehicle status indicative of a status of the self-driving vehicle; and a position transmitting unit that is configured to repeatedly transmit position information indicative a position of the self-driving vehicle to the management device. The management device includes: an abnormality determination unit that is configured to determine whether an abnormality occurs in the self-driving vehicle based on the vehicle status when receiving the vehicle status; a driving settings unit that is configured to: transmit, to the unmanned carrying vehicle, a transport instruction for the unmanned carrying vehicle to transport the self-driving vehicle when the abnormality determination unit determines that an abnormality occurs; and transmit, to the self-driving vehicle, an self-driving instruction for the self-driving vehicle to move by self-driving when the abnormality determination unit determines that an abnormality does not occur; a stop position determination unit that is configured to determine whether the self-driving vehicle stops at a stop position on a path in the parking lot based on the position information transmitted from the self-driving vehicle when the self-driving vehicle is stopped; and a travel transmitting unit that is configured to, when the stop position determination unit determines that the stop position is on a path in the parking lot: generate a travel route from a current location of the unmanned carrying vehicle to the stop position of the self-driving vehicle; and transmit the generated travel route to the unmanned carrying vehicle.

### BRIEF DESCRIPTION OF DRAWINGS

FIG. 1 is a plan view of a parking lot.

FIG. 2 is a block diagram illustrating the configuration of a parking assist system.

FIG. 3 is a diagram of functional blocks in a control unit of a management device.

FIG. 4 is a diagram of functional blocks in a control unit of a self-driving vehicle.

FIG. 5 is a flowchart of a parking setting process executed by the management device.

FIG. 6 is a flowchart of an unmanned carrying vehicle entrance process in the parking setting process.

FIG. 7 is a flowchart of a self-driving vehicle entrance process in the parking setting process.

FIG. 8 is a flowchart of a transport parking process executed by an unmanned carrying vehicle.

FIG. 9 is a flowchart of a self-driving parking process executed by a self-driving vehicle.

FIG. 10 is a flowchart of an exit setting process executed by the management device.

FIG. 11 is a flowchart of an unmanned carrying vehicle exit process in the exit setting process.

FIG. 12 is a flowchart of a self-driving vehicle exit process in the exit setting process.

FIG. 13 is a flowchart of a transport exit process executed by an unmanned carrying vehicle.

FIG. 14 is a flowchart of a self-driving exit process executed by a self-driving vehicle.

### DESCRIPTION OF EMBODIMENTS

To begin with, a relevant technology will be described first only for understanding the following embodiments.

As a result of thorough examination by the inventors, it has been found that there is a problem about the technology described above that it becomes difficult for the self-driving vehicle to move in the parking lot if some abnormality has occurred in the self-driving vehicle. If some abnormality occurs in the self-driving vehicle, it becomes necessary to remove the self-driving vehicle manually, and this is inconvenient.

It is one objective of the present disclosure to provide a parking assist system where a self-driving vehicle can be moved in a parking lot even if an abnormality occurs in the vehicle.

As described above, according to the one aspect of the present disclosure, a parking assist system is configured to assist for a vehicle to park. The parking assist system includes: a self-driving vehicle configured to perform self-driving from a boarding/alighting area to a parking position in a parking lot; an unmanned carrying vehicle that is configured to transport a vehicle in the parking lot; and a management device that is configured to move the self-driving vehicle by the unmanned carrying vehicle between the parking position and the boarding/alighting area by controlling the unmanned carrying vehicle and the self-driving vehicle. The self-driving vehicle includes: a status transmitting unit that is configured to transmit, to the management device, a vehicle status indicative of a status of the self-driving vehicle; and a position transmitting unit that is configured to repeatedly transmit position information indicative a position of the self-driving vehicle to the management device. The management device includes: an abnormality determination unit that is configured to determine whether an abnormality occurs in the self-driving vehicle based on the vehicle status when receiving the vehicle status; a driving settings unit that is configured to: transmit, to the unmanned carrying vehicle, a transport instruction for the unmanned carrying vehicle to transport the self-driving vehicle when the abnormality determination unit determines that an abnormality occurs; and transmit, to the self-driving vehicle, an self-driving instruction for the self-driving vehicle to move by self-driving when the abnormality determination unit determines that an abnormality does not occur; a stop position determination unit that is configured to determine whether the self-driving vehicle stops at a stop position on a path in the parking lot based on the position information transmitted from the self-driving vehicle when the self-driving vehicle is stopped; and a travel transmitting unit that is configured to, when the stop position determination unit determines that the stop position is on a path in the parking lot: generate a travel route from a current location of the unmanned carrying vehicle to the stop position of the self-driving vehicle; and transmit the generated travel route to the unmanned carrying vehicle.

According to another aspect of the present disclosure, a parking assist system is configured to provide assistance of parking for a vehicle. The parking assist system includes: a parking lot including a parking position and a boarding/alighting area; an unmanned carrying vehicle that is configured to transport a vehicle in the parking lot; and a management device configured to move a self-driving vehicle by the unmanned carrying vehicle between the parking position and the boarding/alighting area by controlling the unmanned carrying vehicle and a self-driving vehicle, the self-driving vehicle being configured to perform self-driving from the boarding/alighting area to the parking position. The management device includes: an abnormality determination unit that is configured to determine whether an abnormality occurs in the self-driving vehicle based on a vehicle status transmitted from the self-driving vehicle when the vehicle status is received, the vehicle status indicating a status of the self-driving vehicle; and a driving settings unit that is configured to: transmit, to the unmanned carrying vehicle, a transport instruction for the unmanned carrying vehicle to transport the self-driving vehicle when the abnormality determination unit determines that an abnormality occurs; and transmit, to the self-driving vehicle, a self-driving instruction for the self-driving vehicle to move by self-driving when the abnormality determination unit determines that an abnormality does not occur. The driving settings unit is further configured to transmit the transport instruction to the unmanned carrying vehicle irrespective of the vehicle status when the management device receives an exit request for the self-driving vehicle if the self-driving vehicle was transported by the unmanned carrying vehicle from the boarding/alighting area to the parking position.

According to yet another aspect of the present disclosure, a parking assist system is configured to provide assistance of parking for a vehicle. The parking assist system includes: a parking lot including a parking position and a boarding/alighting area; an unmanned carrying vehicle that is configured to transport a vehicle in the parking lot; a management device configured to move a self-driving vehicle by the unmanned carrying vehicle between the parking position and the boarding/alighting area by controlling the unmanned carrying vehicle and a self-driving vehicle, the self-driving vehicle being configured to perform self-driving from the boarding/alighting area to the parking position; and an infrastructure that is configured to measure the self-driving vehicle. The management device includes: an abnormality determination unit that is configured to determine whether an abnormality occurs in the self-driving vehicle based on a vehicle status transmitted from the self-driving vehicle when the vehicle status is received, the vehicle status indicating a status of the self-driving vehicle; and a driving settings unit that is configured to: transmit, to the unmanned carrying vehicle, a transport instruction for the unmanned carrying vehicle to transport the self-driving vehicle when the abnormality determination unit determines that an abnormality occurs; and transmit, to the self-driving vehicle, a self-driving instruction for the self-driving vehicle to move by self-driving when the abnormality determination unit determines that an abnormality does not occur. The abnormality determination unit is further configured to determine whether the self-driving vehicle matches the parking lot in size (i.e., whether self-driving vehicle is compatible to the parking lot) based on a result of the measurement by the infrastructure.

According to such a configuration, even if some abnormality has occurred in the self-driving vehicle and if it is difficult to cause the self-driving vehicle to perform self-driving in the parking lot, it is possible to cause the self-driving vehicle to move in the parking lot by using the unmanned carrying vehicle.

Hereinafter, an embodiment of the present disclosure is explained with reference to the figures.

### EMBODIMENTS

### 1-1. Configuration of Parking Assist System 1

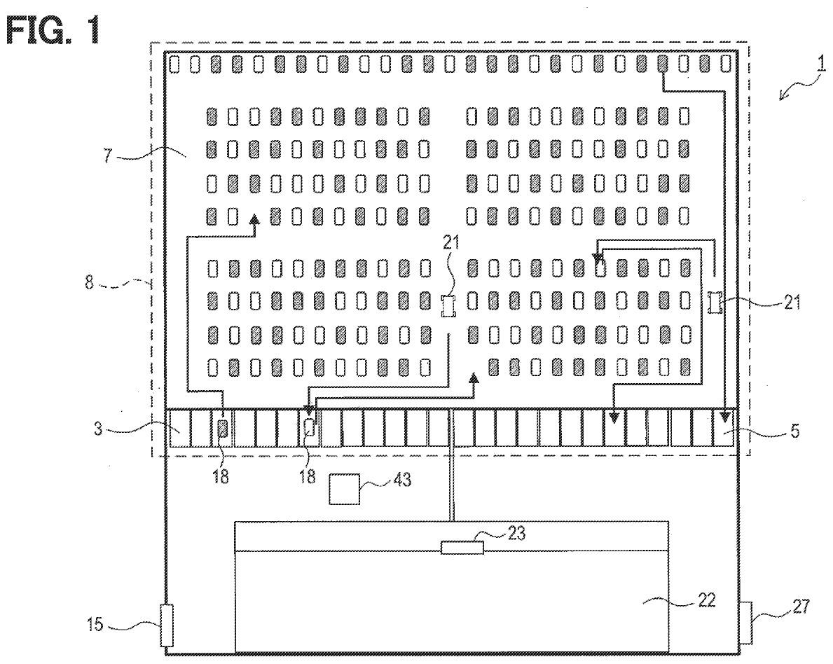

The configuration of a parking assist system 1 is explained on the basis of FIG. 1 to FIG. 3. As illustrated in FIG. 1, the parking assist system 1 includes: an entrance car room 3 set as an alighting area where a user alights from a vehicle; an exit car room 5 set as a boarding area where the user boards the vehicle; and a parking area 7. An area including the entrance car room 3, the exit car room 5, and the parking area 7 is denoted also a parking lot 8 below. The boarding area, and the alighting area are also denoted as a boarding/alighting area.

A plurality of spaces are provided in each of the entrance car room 3, and the exit car room 5. The entrance car room 3 is connected with the outside of the parking assist system 1 via an entrance 15. Each self-driving vehicle 18 can pass through the entrance 15 from the outside, and enter the entrance car room 3. The self-driving vehicle 18 has a self-driving valet parking functionality.

The self-driving vehicle 18 only has to be capable of implementing the self-driving valet parking functionality in the parking lot 8, and needs not to have a functionality of performing self-driving outside the parking lot 8. The self-driving valet parking functionality includes a functionality of travelling, by self-driving, from the entrance car room 3 to a parking position in the parking area 7, and parking at the parking position, and a functionality of travelling, by self-driving, from the parking position in the parking area 7 to the exit car room 5.

In particular, the self-driving valet parking functionality includes a functionality of repeatedly acquiring position information about the self-driving vehicle 18, and transmitting the position information to a management device 39, and a functionality of receiving a guidance route from the management device 39, controlling the self-driving vehicle 18, and causing the self-driving vehicle 18 to travel in accordance with the guidance route. The position information about the self-driving vehicle 18 represents a result of an estimation of the current location of the self-driving vehicle 18, and includes coordinate values in the area of the parking lot 8, for example.

The entrance car room 3, and the exit car room 5 are adjacent to an entrance 23 of a facility 22 such as a store. An occupant of a self-driving vehicle 18 having entered the entrance car room 3 alights from the self-driving vehicle 18, and can walk to the entrance 23.

The exit car room 5 is connected with the outside of the parking assist system 1 via an exit 27. The self-driving vehicle 18 passes through the exit 27 from the exit car room 5, and can travel to the outside of the parking assist system 1. The exit car room 5 is adjacent to the entrance 23. The occupant can walk to the exit car room 5 from the entrance 23.

The parking area 7 is a place where a plurality of self-driving vehicles 18 can be parked. A plurality of spaces are provided inside the parking area 7. Each space provided in the entrance car room 3, the exit car room 5, and the parking area 7 is an area where one self-driving vehicle 18 can be parked.

The self-driving vehicles 18 can travel from the entrance car room 3 to the parking area 7. The self-driving vehicles 18 can travel from the parking area 7 to the exit car room 5.

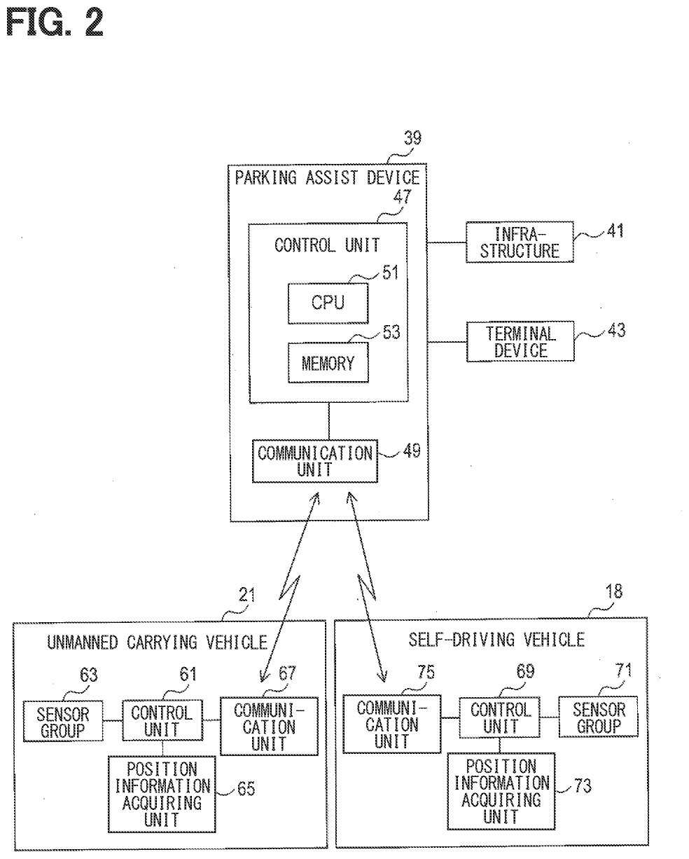

As illustrated in FIG. 2, the parking assist system 1 includes the management device 39, an infrastructure 41, and a terminal device 43. The parking assist system 1 includes a plurality of unmanned carrying vehicles 21.

For example, each unmanned carrying vehicle 21 can travel in a status that a certain vehicle including a self-driving vehicle 18 is placed on the unmanned carrying vehicle 21 (hereinafter, referred to as the placement status). The unmanned carrying vehicle 21 can crawl under the vehicle, and lifts the vehicle to thereby switch between the non-placement status and the placement status. The unmanned carrying vehicle 21 has a functionality of self-driving to a target position along a guidance route provided from the management device 39.

In the placement status, the unmanned carrying vehicle 21 self-drives to the target position along the guidance route, and thereby can transport the vehicle to the target position. The vehicle transported by the unmanned carrying vehicle 21 may be a self-driving vehicle 18 or may be a vehicle which is not a self-driving vehicle 18, that is, a vehicle not having a self-driving functionality. It should be noted however that an unmanned carrying vehicle 21 transports a self-driving vehicle 18 in an example explained below, and a description of an example in which an unmanned carrying vehicle 21 transports a vehicle which is not a self-driving vehicle 18 is omitted.

As illustrated in FIG. 2, an unmanned carrying vehicle 21 includes a control unit 61, a sensor group 63, a position information acquiring unit 65, and a communication unit 67.

The control unit 61 controls the respective units of the unmanned carrying vehicle 21. The self-driving functionality executed by the unmanned carrying vehicle 21 is realized by the control performed by the control unit 61. The control unit 61 retains map information related to the parking lot 8. When performing self-driving, the unmanned carrying vehicle 21 uses the map information, for example.

The sensor group 63 acquires surrounding environment information representing the situation around the unmanned carrying vehicle 21. For example, examples of the content of the surrounding environment information include the positions of obstacles located around the unmanned carrying vehicle 21, and the like. For example, the sensor group 63 includes cameras, lidars, and the like. When performing self-driving, the unmanned carrying vehicle 21 uses the surrounding environment information.

The position information acquiring unit 65 acquires position information about the unmanned carrying vehicle 21. The position information acquiring unit 65 is a GPS system, for example. When performing self-driving, the unmanned carrying vehicle 21 uses the position information. The communication unit 67 can communicate with the management device 39.

The management device 39 includes a control unit 47, and a communication unit 49. The control unit 47 includes a microcomputer having a CPU 51, and a semiconductor memory (hereinafter, referred to as a memory 53) such as a RAM or a ROM, for example.

Respective functionalities of the control unit 47 are realized by the CPU 51 executing a program stored on a non-transitory tangible recording medium. In this example, the memory 53 is equivalent to the non-transitory tangible recording medium storing the program. By executing the program, a method corresponding to the program is executed. The control unit 47 may include one microcomputer or may include a plurality of microcomputers.

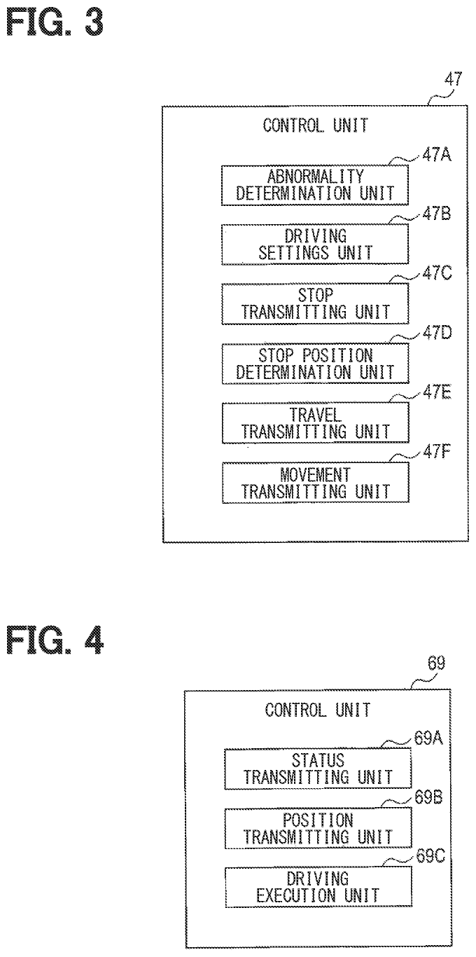

The control unit 47 includes a configuration for transmitting, to a self-driving vehicle 18 and an unmanned carrying vehicle 21, a guidance route to a target position, and various types of instructions. For example, as illustrated in FIG. 3, the control unit 47 includes an abnormality determination unit 47A, a driving settings unit 47B, a stop transmitting unit 47C, a stop position determination unit 47D, a travel transmitting unit 47E, and a movement transmitting unit 47F. Operation of the respective units 47A to 47F included in the control unit 47 is mentioned later.

The memory 53 has map information about the parking lot 8 stored thereon. The map information includes information representing the status of each space in the parking area 7. The status of each space is either a status that the space is available (hereinafter, referred to as the available status) or a status that the space is occupied by a self-driving vehicle 18 (hereinafter, referred to as the occupied status). The communication unit 49 can communicate with self-driving vehicles 18.

The infrastructure 41 includes one which acquires information representing the situation of the inside of the parking assist system 1 (hereinafter, referred to as car-park internal situation information), and supplies the car-park internal situation information to the management device 39. The infrastructure 41 includes cameras that capture images of the inside of the parking assist system 1, lidars, and the like.

For example, examples of the car-park internal situation information include information representing the positions of obstacles, information representing the status of each space in the parking area 7, position information about self-driving vehicles 18 located inside the parking assist system 1, and the like.

As illustrated in FIG. 1, the terminal device 43 is installed near the entrance car room 3. The terminal device 43 accepts input manipulation by occupants. The terminal device 43 outputs, to the management device 39, signals according to the input manipulation.

For example, the terminal device 43 outputs a parking request signal in accordance with input manipulation. The parking request signal is a signal for requesting to transport a self-driving vehicle 18 in the entrance car room 3 to the parking area 7, and park the self-driving vehicle 18. When outputting, to the management device 39, a signal according to input manipulation, the terminal device 43 outputs identification information about the self-driving vehicle 18, or the like.

For example, the terminal device 43 outputs an exit request signal or the like in accordance with input manipulation. The exit request signal is a signal requesting to transport a self-driving vehicle 18 parked in the parking area 7 to the exit car room 5. For example, the terminal device 43 outputs identification information about a self-driving vehicle 18 in accordance with input manipulation. For example, the identification information is information such as a number plate for uniquely specifying a self-driving vehicle 18.

As mentioned above, each self-driving vehicle 18 includes the self-driving valet parking functionality. As illustrated in FIG. 2, the self-driving vehicle 18 includes a control unit 69, a sensor group 71, a position information acquiring unit 73, and a communication unit 75. As illustrated in FIG. 4, the control unit 69 includes a status transmitting unit 69A, a position transmitting unit 69B, and a driving execution instruction 69C. Operation of the respective units 69A to 69C included in the control unit 69 is mentioned later.

The control unit 69 controls the respective units of the self-driving vehicle 18. The self-driving functionality is realized by the control performed by the control unit 69. The self-driving vehicle 18 acquires, from the management device 39, the map information about the parking lot 8, and a guidance route, and uses the map information about the parking lot 8, and the guidance route when performing self-driving.

The sensor group 71 acquires surrounding environment information representing the situation around the self-driving vehicle 18. For example, examples of the content of the surrounding environment information include the positions of obstacles located around the self-driving vehicle 18, and the like. For example, the sensor group 71 includes cameras, lidars, and the like. When performing self-driving, the self-driving vehicle 18 uses the surrounding environment information.

The position information acquiring unit 73 acquires position information about the self-driving vehicle 18. For example, the position information acquiring unit 73 is a position estimation system that uses the lidars and a map. The self-driving vehicle 18 uses the position information when performing self-driving. The communication unit 75 can communicate with the management device 39.

### 1-2. Processes

### 1-2-1. Parking Setting Process Executed by Management Device 39

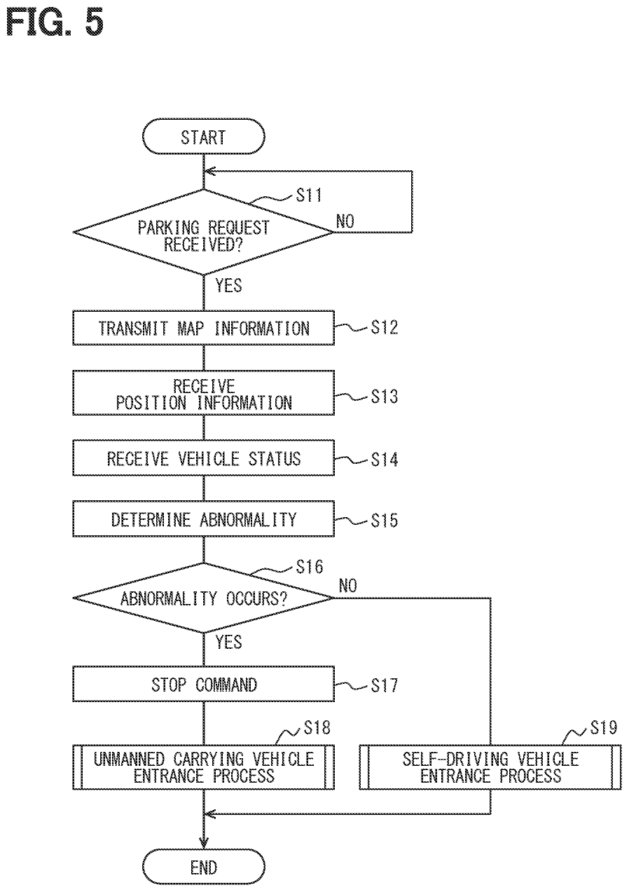

A parking setting process executed by the management device 39 is explained by using FIG. 5. For example, the parking setting process is a process that is started when the power supply of the management device 39 is turned on, and executed repeatedly thereafter.

At Step (hereinafter, abbreviated to “5”) 11 of the parking setting process illustrated in FIG. 5, the driving settings unit 47B of the management device 39 assesses whether or not the parking request signal has been received.

Here, if a user such as an occupant of a self-driving vehicle 18 inputs a parking request by manipulating the terminal device 43, the terminal device 43 transmits, to the management device 39, the parking request signal corresponding to the input. At this time, the user inputs, to the terminal device 43, vehicle information such as the number plate for specifying the vehicle, a user ID for specifying the user, user information such as a password, and other necessary information.

If the terminal device 43 is manipulated, unique information such as an ID for specifying the terminal device 43, the vehicle information, the user information, and the like are transmitted to the management device 39. After the manipulation for the parking request, the user can leave the parking lot 8, and head to a destination.

Subsequently, at S12, the driving settings unit 47B transmits the map information about the parking lot 8 to the self-driving vehicle 18. That is, if the user performs input for starting parking on the terminal device 43, the driving settings unit 47B transmits the map information about the parking lot 8 to the self-driving vehicle 18.

The self-driving vehicle 18 is set such that, after having received the map information, the self-driving vehicle 18 returns position information and a vehicle status as mentioned later. At S13, the driving settings unit 47B receives the position information transmitted from the self-driving vehicle 18. Subsequently, the process proceeds to S14, and the abnormality determination unit 47A of the management device 39 receives the vehicle status transmitted from the self-driving vehicle 18.

Here, the vehicle status represents the status of the self-driving vehicle 18. More specifically, the vehicle status represents data with which an abnormality diagnosis is possible, such as a result of a malfunction diagnosis at the self-driving vehicle 18 or sensor values such as the air pressure, temperature or remaining fuel of the self-driving vehicle 18.

Subsequently, at S15, the abnormality determination unit 47A performs an abnormality determination of the self-driving vehicle 18 on the basis of the vehicle status. For example, the abnormality determination unit 47A compares the vehicle status and a reference value or reference range set in advance, and if the vehicle status becomes larger than the reference value which is an upper limit value, falls below the reference value which is a lower limit value or is outside the reference range, assesses that there is an abnormality in the self-driving vehicle 18. If the abnormality determination unit 47A has received a malfunction diagnosis result representing that there is a malfunction also, the abnormality determination unit 47A assesses that there is an abnormality in the self-driving vehicle 18.

Subsequently, at S16, the abnormality determination unit 47A assesses whether or not there is an anomaly. If there is an anomaly, the process proceeds to S17, and the stop transmitting unit 47C of the management device 39 transmits a stop command to the self-driving vehicle 18. This stop command is transmitted independently of whether or not the self-driving vehicle 18 is travelling.

At S17, the management device 39 transmits a notification that an unmanned carrying vehicle 21 is used for the self-driving vehicle 18. At S17, the management device 39 may transmit, to the user, a notification for inquiring whether or not the user allows the use of an unmanned carrying vehicle 21 for entrance of the self-driving vehicle 18. In this case, if the user selects the entrance by using an unmanned carrying vehicle 21, an unmanned carrying vehicle entrance process at S18 is implemented. If the user rejects the entrance by using an unmanned carrying vehicle 21, parking in the parking area 7 is rejected, and the parking setting process is ended.

Subsequently, at S18, the management device 39 implements the unmanned carrying vehicle entrance process. The unmanned carrying vehicle entrance process is a process of moving a self-driving vehicle 18 to a parking position by using an unmanned carrying vehicle 21. When the unmanned carrying vehicle entrance process is ended, the management device 39 ends the parking setting process.

On the other hand, if it is assessed at S16 that there is not an anomaly, the process proceeds to S19, and, at S19, the management device 39 implements a self-driving vehicle entrance process. The self-driving vehicle entrance process is a process of causing a self-driving vehicle 18 to move to a parking position by self-driving. When the self-driving vehicle entrance process is ended, the management device 39 ends the parking setting process.

In running the parking assist system 1, a manager wants to cause a vehicle to enter the parking area 7 by using an unmanned carrying vehicle 21 in some cases, and wants to operate an unmanned carrying vehicle 21 in some other cases. The parking assist system 1 may assess whether or not the manager is requesting to implement parking of a vehicle by the unmanned carrying vehicle entrance process. This determination may be implemented independently from the flowchart of the parking setting process or may be implemented at a certain step in the flowchart. For example, even if there is not an abnormality in the self-driving vehicle 18 (if No at S16), the management device 39 may implement the unmanned carrying vehicle entrance process (S18), not the self-driving vehicle entrance process (S19), provided that there is a request of the manager to use an unmanned carrying vehicle 21.

### 1-2-2. Unmanned Carrying Vehicle Entrance Process

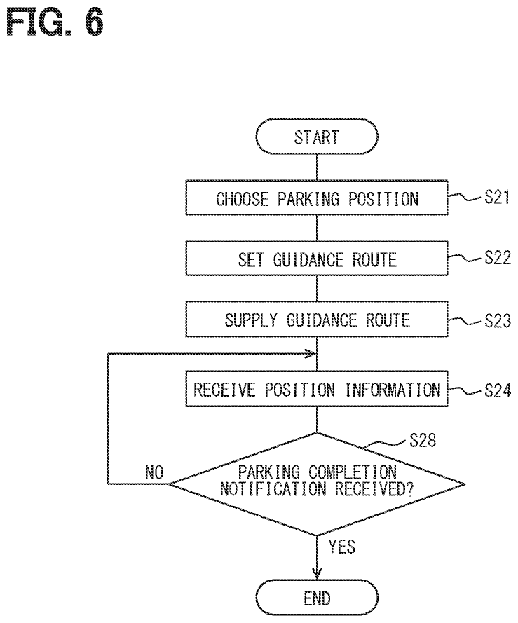

The unmanned carrying vehicle entrance process executed by the management device 39 is explained by using FIG. 6. In the unmanned carrying vehicle entrance process, first at S21, the driving settings unit 47B of the management device 39 chooses a parking position.

As the parking position, a space in the available status in the parking area 7 is chosen. For example, the driving settings unit 47B assesses the status of each space in the following manner. When a self-driving vehicle 18 to be parked at a space, the self-driving vehicle 18 sends, to the management device 39, identification information about the space, and information about the start of the parking. When transporting a vehicle out of a space, an unmanned carrying vehicle 21 sends, to the management device 39, identification information about the space, and information about the end of the parking. When the self-driving vehicle 18 leaves the space where the self-driving vehicle 18 has been parked, the self-driving vehicle 18 sends, to the management device 39, the identification information about the space, and information about the end of the parking.

On the basis of the history of information sent from self-driving vehicles 18, the driving settings unit 47B assesses the status of each space. The driving settings unit 47B may assess the status of each space on the basis of information supplied by the infrastructure 41.

If there is only one space in the available status, the driving settings unit 47B chooses the space as the parking position. If there are a plurality of spaces in the available status, the driving settings unit 47B chooses one space as the parking position from the plurality of spaces in the available status on the basis of a predetermined criterion. For example, the criterion may be that the space closest to the entrance car room 3 is chosen, that the space closest to the exit car room 5 is chosen, that a space in an area where there are many spaces in the available status is chosen, and so on.

At S22, the driving settings unit 47B sets a guidance route by using the map information about the parking lot 8. Here, a route from the current location of the unmanned carrying vehicle 21 through the current location of the self-driving vehicle 18 to the parking position chosen at S21 is set as a guidance route on which the unmanned carrying vehicle 21 should travel.

Subsequently, at S23, by using the communication unit 49, the driving settings unit 47B transmits information representing the guidance route set at S22 (hereinafter, referred to as guidance route information). In the unmanned carrying vehicle entrance process, the guidance route information is transmitted to the unmanned carrying vehicle 21.

When the guidance route information is transmitted to the unmanned carrying vehicle 21, a notification that the self-driving vehicle 18 is transported by the unmanned carrying vehicle 21 may be transmitted to the self-driving vehicle 18. The guidance route information doubles as an instruction, given to the unmanned carrying vehicle 21, to start the parking. That is, the guidance route information is the transport instruction of the present disclosure. As mentioned later, the unmanned carrying vehicle 21 receives the guidance route information, and self-driving according to the guidance route is started.

Subsequently, at S24, the driving settings unit 47B acquires the position information about the unmanned carrying vehicle 21. Subsequently, at S28, the driving settings unit 47B assesses whether or not the communication unit 49 has received a parking completion notification. The parking completion notification is a notification transmitted by the unmanned carrying vehicle 21 when the self-driving vehicle 18 has been parked at a target position which is the end point of the guidance route, the parking position in this case. If the parking completion notification has been received, the driving settings unit 47B ends the present process. If the parking completion notification has not been received, the process returns to S24.

### 1-2-3. Self-Driving Vehicle Entrance Process

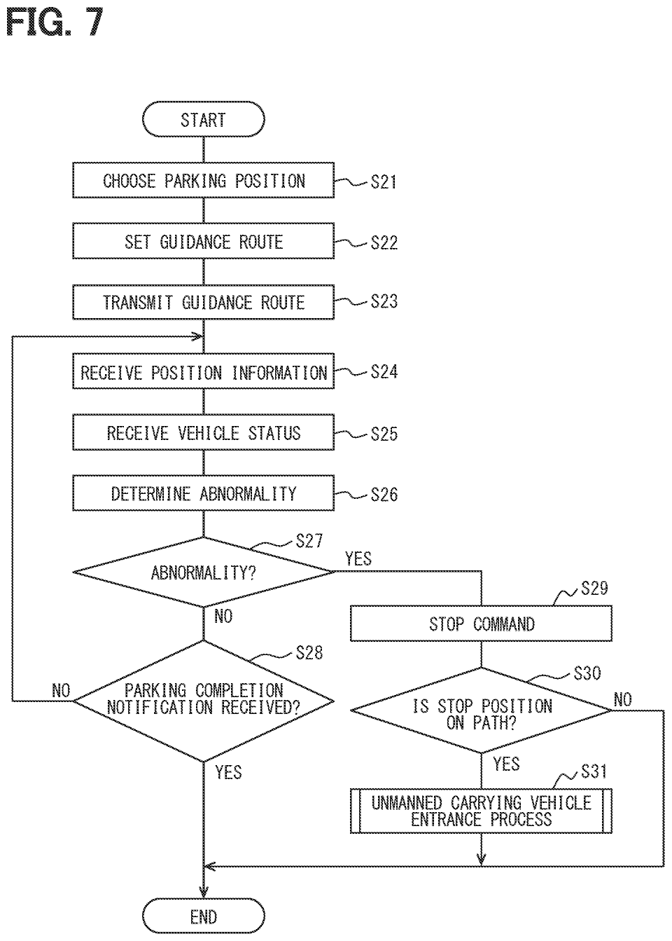

The self-driving vehicle entrance process executed by the management device 39 is explained by using FIG. 7. In the self-driving vehicle entrance process, the processes at S21 to S24 are implemented, similar to the unmanned carrying vehicle entrance process. At S22, the driving settings unit 47B sets a guidance route for the self-driving vehicle 18 to travel by self-driving, and sets a route from the current location of the self-driving vehicle 18 to the parking position chosen at S21. At S23, the driving settings unit 47B transmits the guidance route information to the self-driving vehicle 18.

The guidance route information transmitted at S23 doubles as an instruction for the start of parking of the self-driving vehicle 18. That is, the guidance route information is the self-driving instruction of the present disclosure. As mentioned later, the self-driving vehicle 18 receives the guidance route information, and self-driving according to the guidance route is started. At S24, the driving settings unit 47B acquires the position information about the self-driving vehicle 18.

Subsequently, at S25, the abnormality determination unit 47A receives a vehicle status. The vehicle status here is similar to the vehicle status received at S14. Subsequently, at S26, the abnormality determination unit 47A assesses whether or not there is an anomaly. If it is assessed at S27 that there is an anomaly, the process proceeds to S29, and the stop transmitting unit 47C of the management device 39 transmits a stop command to the self-driving vehicle 18.

At S26, it may be assessed whether or not the vehicle position specified by the position information received at S24 or the vehicle position detected via the infrastructure 41 is included in travel boundaries specified by the guidance route set at S22, and if the vehicle position is out of the travel boundaries, it may be assessed that there is an anomaly. The managing device 39 sets a permitted width of travelling of the vehicle in the vehicle width direction of the guidance route, taking into consideration measurement errors of sensors, differences in behaviors and control between vehicles, and the like. Both ends of the permitted width of travelling of the vehicle are equivalent to the travel boundaries.

Subsequently, at S30, the stop position determination unit 47D of the management device 39 performs a path determination. The path determination is a process of assessing whether or not the stop position of a self-driving vehicle 18 is on a path if the self-driving vehicle 18 has stopped after receiving a stop command. The path represents an area other than a plurality of spaces of the parking lot 8. If the stop position is on the path, at S31, the management device 39 implements the unmanned carrying vehicle entrance process. That is, the travel transmitting unit 47E of the management device 39 implements a process of generating a travel route from the current location of the unmanned carrying vehicle 21 to the stop position, and transmitting the travel route to the unmanned carrying vehicle 21.

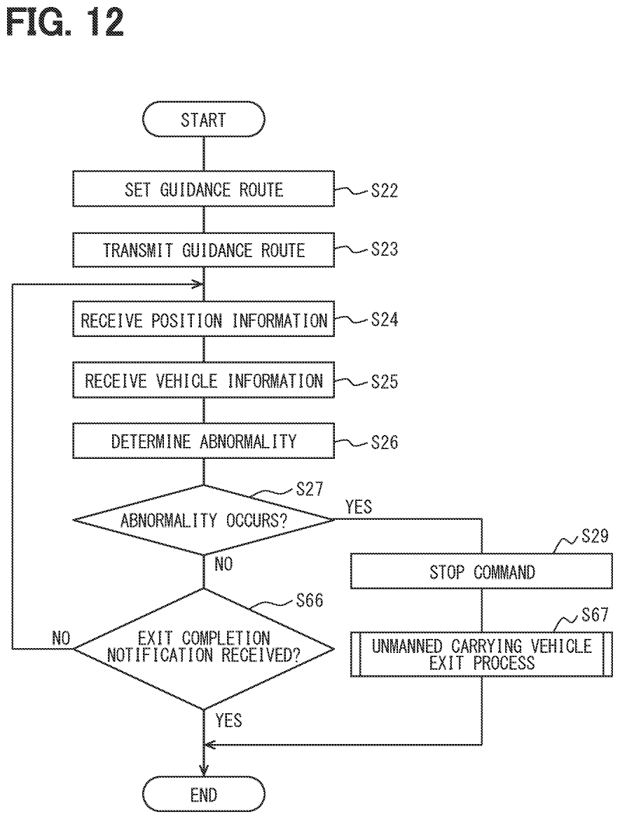

The unmanned carrying vehicle entrance process is similar to the process mentioned above. That is, in this configuration, at S31, by suspending the self-driving vehicle entrance process, and implementing the unmanned carrying vehicle entrance process as an interrupting process, the self-driving vehicle 18 in which an abnormality has occurred can be saved by the unmanned carrying vehicle 21. When such an unmanned carrying vehicle entrance process is ended, the management device 39 ends the self-driving vehicle entrance process, and the parking setting process. If it is assessed at S30 that the stop position is not on the path, the management device 39 may omit the process at S31. In an unmanned carrying vehicle exit process mentioned later also (see FIG. 12), the process at S30 described above may be implemented after the process at S29.

In this manner, by suspending the self-driving vehicle entrance process (or the self-driving vehicle exit process), and implementing the unmanned carrying vehicle entrance process (or the unmanned carrying vehicle exit process) as an interrupting process, the self-driving vehicle 18 in which an abnormality has occurred can be guided promptly to a target position. It becomes unnecessary for an operator or a user to head to the site for removing the self-driving vehicle even if it becomes not possible for the self-driving vehicle 18 to travel by self-driving. If an abnormality is confirmed at S27, information to that effect may be stored on the memory 53. In this case, when the user transmits the exit request signal to the management device 39, information that an abnormality has been confirmed in the vehicle status at the time of entrance, and the self-driving vehicle 18 has been transported by an unmanned carrying vehicle 21 may be notified through the terminal device 43.

On the other hand, if it is assessed at S27 that there is not an anomaly, the process proceeds to S28, and the driving settings unit 47B assesses whether or not the communication unit 49 has received a parking completion notification. The parking completion notification here is a notification transmitted by the self-driving vehicle 18 when the self-driving vehicle 18 is parked at the parking position, which is the end point of the guidance route. If the parking completion notification has been received, the driving settings unit 47B ends the present process. If the parking completion notification has not been received, the process returns to S24.

### 1-2-4. Transport Parking Process Executed by Unmanned carrying vehicle 21

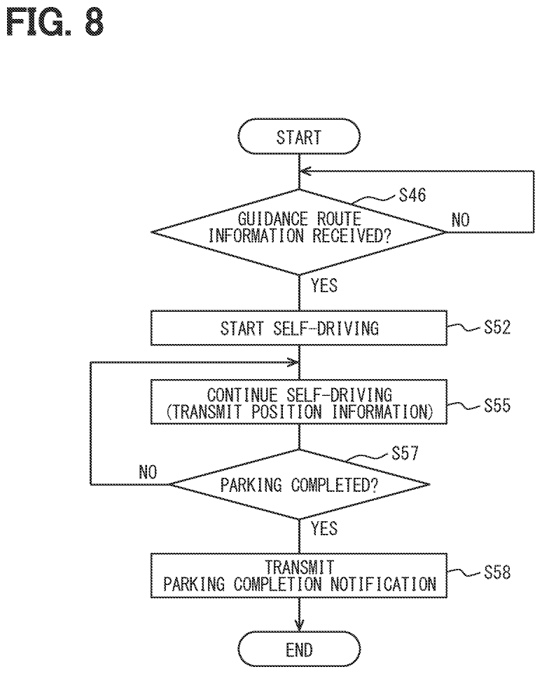

A transport parking process executed by an unmanned carrying vehicle 21 is explained on the basis of FIG. 8. The transport parking process is a process of transporting a self-driving vehicle 18 from the entrance car room 3 to a parking position in accordance with the unmanned carrying vehicle entrance process executed by the management device 39.

At S46, the control unit 61 of the unmanned carrying vehicle 21 assesses whether or not the communication unit 67 has received the guidance route information. Guidance route information is transmitted by the management device 39. If guidance route information has been received, the present process procedure proceeds to S52. If guidance route information has not been received, the present process returns to S46.

At S52, the control unit 61 starts self-driving. When performing the self-driving, the control unit 61 causes the unmanned carrying vehicle 21 to travel on the basis of the guidance route information. The unmanned carrying vehicle 21 is caused to travel due to the self-driving.

Subsequently, at S55, the control unit 61 continues the self-driving. At this time, the control unit 61 repeatedly transmits the position information about the unmanned carrying vehicle 21 to the management device 39 until it is assessed at S57 mentioned later that the parking has been completed. The transmitted position information is received by the management device 39. At S55, during the self-driving, the unmanned carrying vehicle 21 makes the self-driving vehicle 18 placed thereon.

Subsequently, at S57, the control unit 61 assesses whether or not the parking has been completed. That the parking has been completed means that the unmanned carrying vehicle 21 and the self-driving vehicle 18 arrive at the parking position. If the parking has been completed, the present process proceeds to S58. If the parking has not been completed, the present process returns to S55.

At S58, the control unit 61 transmits the parking completion notification by using the communication unit 67, and ends the transport parking process. The management device 39 receives the transmitted parking completion notification. After the parking has been completed, the unmanned carrying vehicle 21 leaves the self-driving vehicle 18 for performing next transportation.

### 1-2-5. Self-Driving Parking Process Executed by Self-Driving Vehicle 18

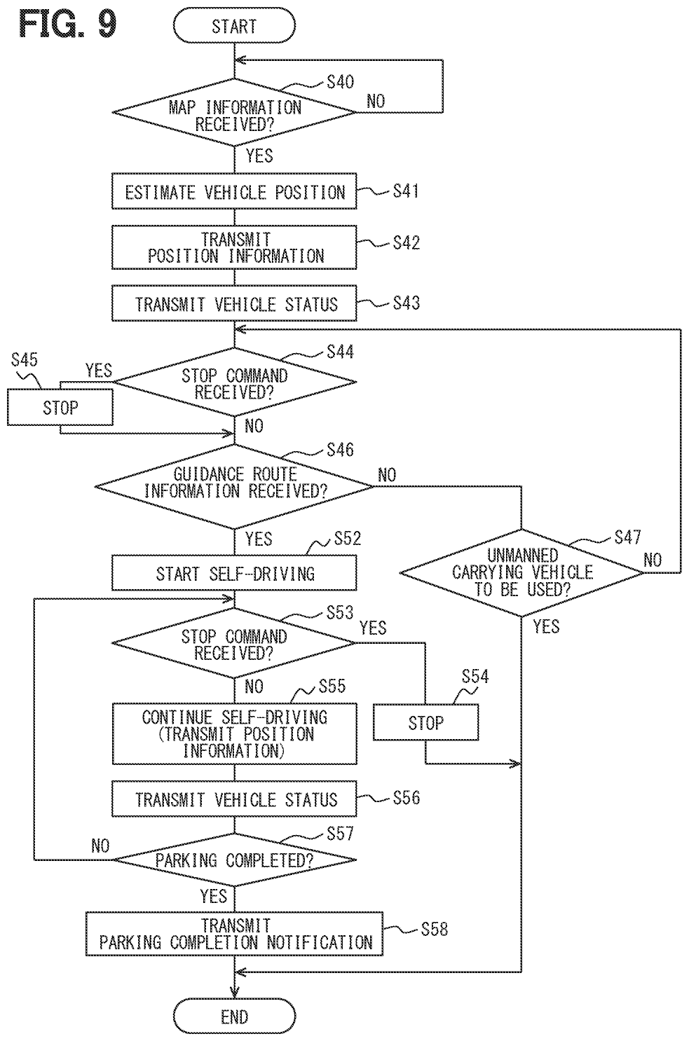

A self-driving parking process executed by a self-driving vehicle 18 is explained by using FIG. 9. The self-driving parking process is a process of causing a self-driving vehicle 18 to self-drive from the entrance car room 3 to a parking position in accordance with the self-driving vehicle entrance process executed by the management device 39.

At S40, the position transmitting unit 69B of the control unit 69 assesses whether or not the communication unit 75 has received the map information about the parking lot 8. If the map information has not been received, the process returns to S40.

If the map information has been received, the process proceeds to S41, and the position transmitting unit 69B estimates the current location of the self-driving vehicle 18. At S42, an estimation result of the current location is transmitted as position information about the self-driving vehicle 18 to the management device 39.

Subsequently, at S43, the status transmitting unit 69A of the self-driving vehicle 18 acquires a vehicle status from the sensor group 71, and transmits the vehicle status to the management device 39. The vehicle status is one mentioned above.

Subsequently, at S44, the driving execution instruction 69C of the self-driving vehicle 18 assesses whether or not a stop command has been received. If a stop command has been received, the process proceeds to S45, the driving execution instruction 69C stops the self-driving vehicle 18, and the process proceeds to S46.

If a stop command has not been received at S44, at S46, the driving execution instruction 69C assesses whether or not guidance route information has been received. If guidance route information has not been received at S46, at S47, the driving execution instruction 69C assesses whether or not a notification instructing to use an unmanned carrying vehicle 21 has been received from the management device 39. If a notification instructing to use an unmanned carrying vehicle 21 has been received, the present process is ended. If a notification instructing to use an unmanned carrying vehicle 21 has not been received, the process returns to S44.

If guidance route information has been received at S46, at S52, the driving execution instruction 69C starts self-driving of the self-driving vehicle 18. When performing self-driving, the driving execution instruction 69C causes the self-driving vehicle 18 to travel in accordance with a guidance route included in the guidance route information.

Subsequently, at S53, the driving execution instruction 69C assesses whether or not a stop command has been received. If a stop command has been received, the process proceeds to S54, the driving execution instruction 69C stops the self-driving vehicle 18, and the present process is ended. The self-driving vehicle 18 is transported by an unmanned carrying vehicle 21.

If a stop command has not been received at S53, at S55, the driving execution instruction 69C continues self-driving of the self-driving vehicle 18. At this time, the driving execution instruction 69C repeatedly transmits the position information about the self-driving vehicle 18 to the management device 39 until it is assessed at S57 mentioned later that the parking has been completed. At S56, the status transmitting unit 69A repeatedly transmits a vehicle status to the management device 39. The transmitted position information, and vehicle status are received by the management device 39. Subsequently, at S57, the driving execution instruction 69C assesses whether or not the parking has been completed. That the parking has been completed means that the self-driving vehicle 18 arrives at the parking position set by the management device 39. If the parking has not been completed, the process returns to S57.

If the parking has been completed, the process proceeds to S58, the driving execution instruction 69C transmits a parking completion notification by using the communication unit 75, and the present process is ended. The management device 39 receives the transmitted parking completion notification.

### 1-2-7. Exit Setting Process Executed by Management Device 39

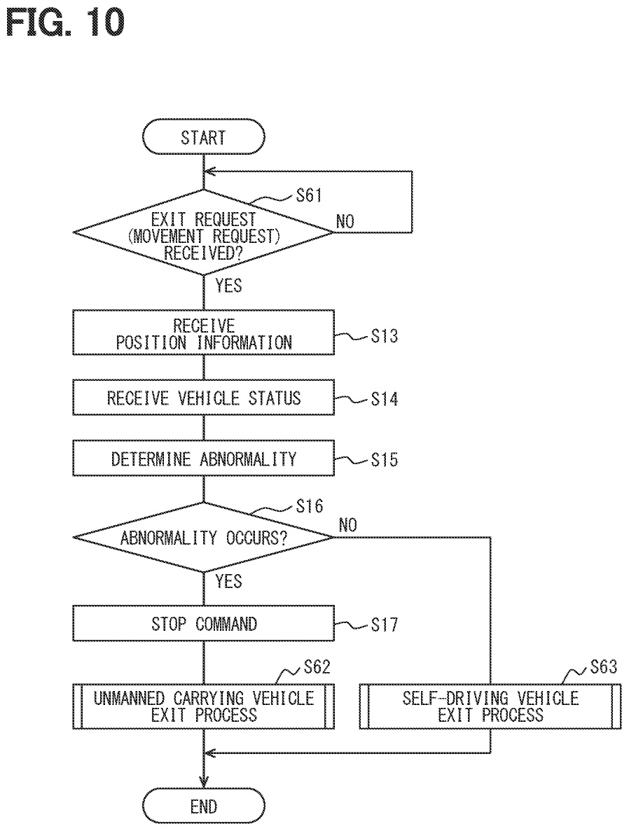

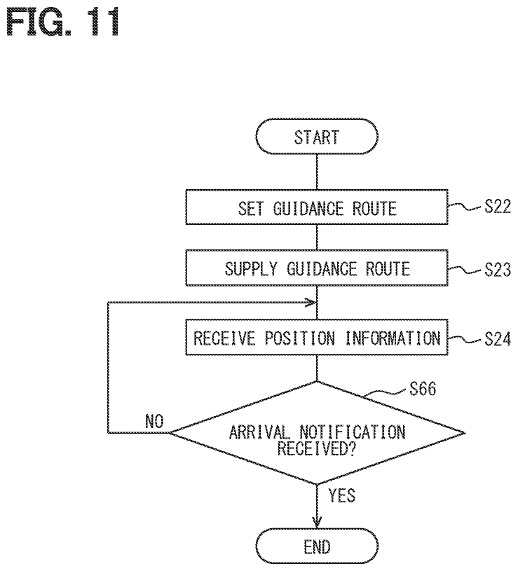

An exit setting process executed by the management device 39 is explained on the basis of FIG. 10. The exit setting process is a process of moving a self-driving vehicle 18 from a parking position to the exit car room 5 by using an unmanned carrying vehicle 21 or by self-driving of the self-driving vehicle 18.

For example, the exit setting process is a process repeatedly implemented in parallel with other processes, by the control unit 47 of the management device 39. In the exit setting process, first at S61, the driving settings unit 47B of the management device 39 assesses whether or not an exit request signal has been received. Here, the exit request signal is a signal representing a request that the self-driving vehicle 18 be moved from the parking position to the exit car room 5, and when a user manipulates the terminal device 43 to input an exit request, the terminal device 43 transmits the exit request signal to the management device 39.

If no exit request signals have been received, S61 is repeated. If an exit request signal has been received, the processes at S13 to S17 mentioned above are implemented. If it is assessed at S16 that there is an anomaly, at S62, the control unit 47 of the management device 39 implements the unmanned carrying vehicle exit process after the process at S17. The unmanned carrying vehicle exit process is a process of causing a self-driving vehicle 18 to move to the exit car room 5 by using an unmanned carrying vehicle 21. If it is assessed at S16 that there is not an anomaly, at S63, the control unit 47 implements the self-driving vehicle exit process. The self-driving vehicle entrance process is a process of causing a self-driving vehicle 18 to move to the exit car room 5 by self-driving.

If any of these processes is ended, the control unit 47 ends the present process.

### 1-2-8. Unmanned Carrying Vehicle Exit Process

The unmanned carrying vehicle exit process executed by the management device 39 is explained on the basis of FIG. 11. In the unmanned carrying vehicle exit process, as illustrated in FIG. 11, S22 to S24 in the unmanned carrying vehicle entrance process (FIG. 6) mentioned above are implemented. After S24, at S66, the driving settings unit 47B assesses whether or not an exit completion notification has been received. The exit completion notification is a notification transmitted from an unmanned carrying vehicle 21 when the unmanned carrying vehicle 21 has transported a self-driving vehicle 18 to the exit car room 5, which is the target position. Alternatively, the exit completion notification is a notification transmitted from a self-driving vehicle 18 when the self-driving vehicle 18 has arrived at the exit car room 5, which is the target position, by self-driving.

If no exit completion notifications have been received, the driving settings unit 47B returns to the process at S24, and if an exit completion notification has been received, the present process is ended.

### 1-2-9. Self-Driving Vehicle Exit Process

The self-driving vehicle exit process executed by the management device 39 is explained on the basis of FIG. 12. In the self-driving vehicle exit process, as illustrated in FIG. 12, S22 to S27, and S29 in the self-driving vehicle entrance process mentioned above are implemented. If it is assessed at S27 that there is an anomaly, at S67, the unmanned carrying vehicle exit process mentioned above is implemented after the process at S29.

If it is assessed at S27 that there is an anomaly, at S66, the driving settings unit 47B assesses whether or not an exit completion notification has been received. If no exit completion notifications have been received, the driving settings unit 47B returns to the process at S24, and if an exit completion notification has been received, the present process is ended.

### 1-2-10. Transport Exit Process Executed by Unmanned Carrying Vehicle 21

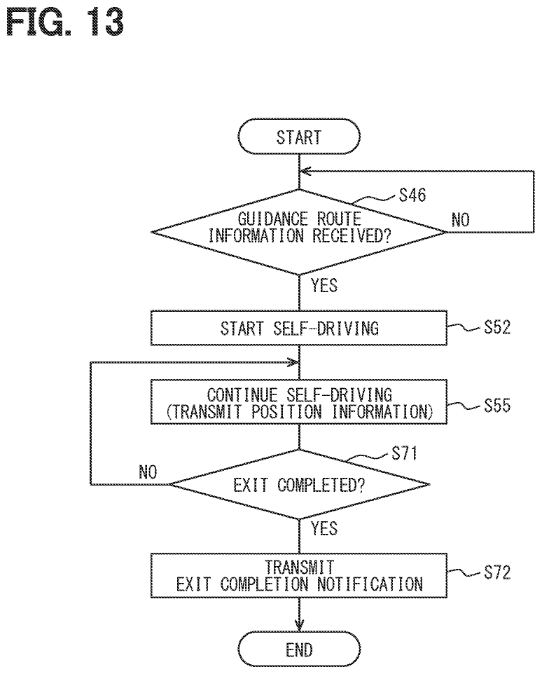

A transport exit process executed by the unmanned carrying vehicle 21 is explained on the basis of FIG. 13. The transport exit process is a process of transporting a self-driving vehicle 18 from a parking position to the exit car room 5 in accordance with the unmanned carrying vehicle exit process executed by the management device 39.

In the transport exit process, as illustrated in FIG. 13, the processes at S46, S52, and S55 in the transport parking process mentioned above are implemented. After S55, at S71, the control unit 61 of the unmanned carrying vehicle 21 assesses whether or not an exit has been completed. For example, if it is sensed that the unmanned carrying vehicle 21 has arrived at the exit car room 5, which is the target position, the control unit 61 assesses that the exit has been completed.

If the exit has not been completed, the process returns to S55. If the exit has been completed, at S72, the control unit 61 transmits an exit completion notification to the management device 39, and the transport exit process is ended.

### 1-2-11. Self-Driving Exit Process Executed by Unmanned Carrying Vehicle 21

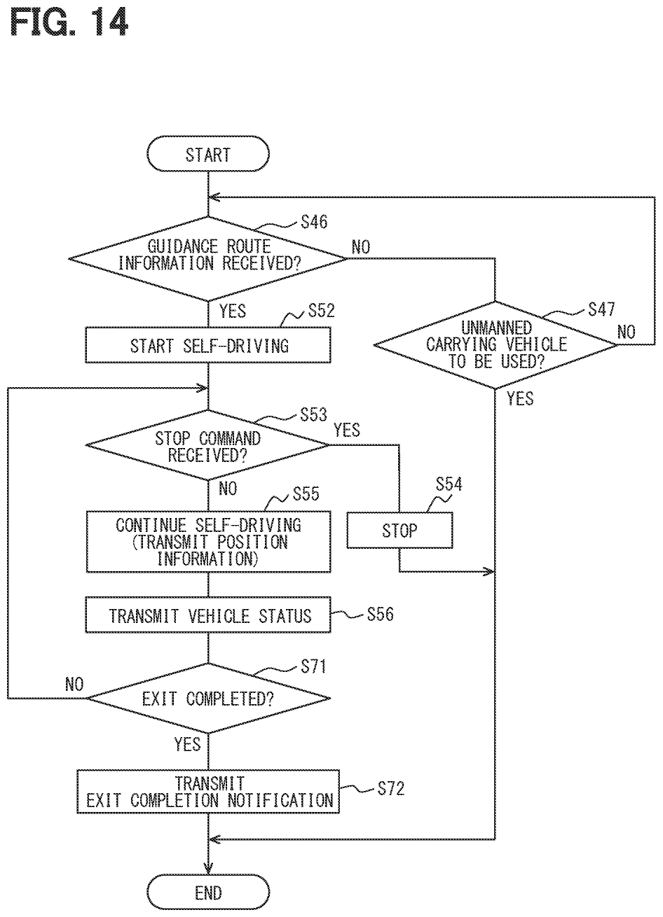

A self-driving exit process executed by the self-driving vehicle 18 is explained on the basis of FIG. 14. The self-driving exit process is a process of causing a self-driving vehicle 18 to travel from a parking position to the exit car room 5 in accordance with the self-driving vehicle exit process executed by the management device 39.

In the self-driving exit process, as illustrated in FIG. 14, the processes at S46, S47, and S52 to S56 in the self-driving exit process mentioned above are implemented. After S56, at S71, the driving execution instruction 69C of the self-driving vehicle 18 assesses whether or not the exit has been completed. If it is sensed that the self-driving vehicle 18 has arrived at the exit car room 5, which is the target position, the driving execution instruction 69C assesses that the exit has been completed.

If the exit has not been completed, the process returns to S53. If the exit has been completed, the driving execution instruction 69C transmits an exit completion notification to the management device 39, and the self-driving exit process is ended.

### 1-3. Advantageous Effects

According to the embodiment mentioned in detail above, the following advantageous effects can be attained.

(1a) One aspect of the present disclosure is the parking assist system 1 configured to assist a vehicle to park. The parking assist system 1 includes: the parking lot 8 including parking positions, and a boarding/alighting area; a self-driving vehicle 18; an unmanned carrying vehicle 21; and the management device 39. The self-driving vehicle 18 is configured to be capable of implementing self-driving from the boarding/alighting area in the parking lot 8 to a parking position. The unmanned carrying vehicle 21 is configured to be capable of transporting vehicles in the parking lot 8. The management device 39 is configured to move at least the self-driving vehicle 18 between parking positions and the boarding/alighting area by controlling the unmanned carrying vehicle 21, and the self-driving vehicle 18.

The self-driving vehicle 18 includes the status transmitting unit 69A configured to transmit, to the management device 39, a vehicle status representing the status of the self-driving vehicle 18. The management device 39 includes the abnormality determination unit 47A, and the driving settings unit 47B.

The abnormality determination unit 47A is configured to assess whether or not an abnormality has occurred in the self-driving vehicle 18 on the basis of the vehicle status when the vehicle status has been received. The driving settings unit 47B is configured to transmit, to the unmanned carrying vehicle 21, a transport instruction for transporting the self-driving vehicle 18 if the abnormality determination unit 47A assesses that an abnormality has occurred, and transmits an self-driving instruction for causing the self-driving vehicle 18 to travel by self-driving if the abnormality determination unit 47A assesses that an abnormality has not occurred.

According to such a configuration, even if some abnormality has occurred in the self-driving vehicle 18, and it is difficult to cause the self-driving vehicle 18 to travel by self-driving in the parking lot 8, it is possible to cause the self-driving vehicle 18 to move in the parking lot 8 by using the unmanned carrying vehicle 21. The parking assist system 1 may be a configuration not including at least either the parking lot 8 or the self-driving vehicle 18.

(1b) The status transmitting unit 69A of the self-driving vehicle 18 is configured to transmit, to the management device 39, the vehicle status during self-driving in the parking lot 8 after receiving the self-driving instruction from the driving settings unit 47B. On the other hand, the abnormality determination unit 47A of the management device 39 is configured to receive the vehicle status representing the status of the self-driving vehicle from the self-driving vehicle during the self-driving in the parking lot after the self-driving vehicle starts travelling by self-driving.

According to such a configuration, even if an abnormality has occurred in the self-driving vehicle 18 during movement of the self-driving vehicle 18 in the parking lot 8, the self-driving vehicle 18 can be moved by using the unmanned carrying vehicle 21.

(1c) The stop transmitting unit 47C of the management device 39 is configured to transmit a stop command to the self-driving vehicle 18 if an abnormality has occurred in the self-driving vehicle 18.

According to such a configuration, because the self-driving vehicle 18 can be stopped, it becomes possible to reduce the likelihood that a further malfunction due to continued movement of the self-driving vehicle 18 occurs.

(1d) In one aspect of the present disclosure, the position transmitting unit 69B of the self-driving vehicle 18 is configured to repeatedly transmit the position of the self-driving vehicle 18 to the management device 39. The stop position determination unit 47D of the management device 39 is configured to assess whether or not the stop position of the self-driving vehicle 18 is on a path in the parking lot 8 if the self-driving vehicle 18 is stopped. The travel transmitting unit 47E is configured to generate a travel route from the current location of the unmanned carrying vehicle 21 to the stop position, and transmit the travel route to the unmanned carrying vehicle 21 if the stop position is on the path in the parking lot 8.

According to such a configuration, it is possible to remove the self-driving vehicle 18 having stopped on the path, by using the unmanned carrying vehicle 21.

### 2. Other Embodiments

Whereas an embodiment of the present disclosure has been explained thus far, the present disclosure is not limited to the embodiment mentioned above, but can be implemented by being modified variously.

(2a) Whereas entrances and exits are explained in the embodiment described above, this is not the sole example. For example, the configuration described above may be applied when the self-driving vehicle 18 is moved to another parking position in the parking lot 8. Specifically, the management device 39 may implement the processes at and after S13 not only if, at S61 in the exit setting process in FIG. 10, the management device 39 receives an exit request signal, but also if a movement request signal is received.

The movement request signal is generated inside the management device 39 for, as a target vehicle, a vehicle other than an entering or exiting vehicle if, when a parking request signal or an exit request signal is received, it is not possible to cause the entering or exiting vehicle to enter or exit unless the vehicle other than the entering or exiting vehicle is moved.

In this case, at S23, the movement transmitting unit 47F of the management device 39 transmits, to the self-driving vehicle 18 being parked at a parking position in the parking lot 8, a movement instruction which is an instruction for moving the self-driving vehicle 18 to another parking position in the parking lot 8 or to an evacuation position for evacuating temporarily. At S56, the status transmitting unit 69A of the self-driving vehicle 18 transmits a vehicle status to the management device 39 after receiving the movement instruction.

According to such a configuration, because the self-driving vehicle 18 transmits the vehicle status to the management device 39 when the self-driving vehicle 18 moves between parking positions in the parking lot 8, the management device 39 can recognize an abnormality of the self-driving vehicle 18. Therefore, even if an abnormality has occurred in the self-driving vehicle 18, the self-driving vehicle 18 can be transported by using the unmanned carrying vehicle 21.

(2b) Whereas a vehicle is stopped immediately if there is an abnormality in the vehicle in the embodiment described above, the vehicle may be stopped in an evacuation space set in advance. The evacuation space may be set in a position which does not become an obstacle to travelling of other vehicles, for example on a path where a plurality of vehicles can pass by each other, or the like.

(2c) Whereas the management device 39 is set such that the management device 39 transports the self-driving vehicle 18 by using the unmanned carrying vehicle 21 if there is an abnormality in the vehicle in the embodiment described above, this configuration is not the sole example. For example, the management device 39 may store, on the memory 53, information that the self-driving vehicle 18 has been caused to enter by using the unmanned carrying vehicle 21 if there is an abnormality when the self-driving vehicle 18 enters, and the self-driving vehicle 18 is caused to enter by using the unmanned carrying vehicle 21. If the self-driving vehicle 18 having been caused to enter by using the unmanned carrying vehicle 21 exits, the management device 39 may cause the self-driving vehicle 18 to exit by using the unmanned carrying vehicle 21 independently of the vehicle status of a self-driving vehicle 39.

(2d) The abnormality determination unit 47A may assess whether or not there is an abnormality on the basis of a deviation distance between a position represented by position information about the self-driving vehicle 18 estimated by the position information acquiring unit 73, and a position represented by position information about the self-driving vehicle 18 detected by the management device 39 on the basis of information supplied by the infrastructure 41.

In this case, the infrastructure 41 includes markers arranged in the parking lot 8, in addition to cameras that capture images inside the parking assist system 1, lidars and the like. For example, the markers are set in areas from the entrance 15 of the parking lot 8 to the entrance car room 3, the inside of the entrance car room 3, and the parking area 7. For example, the position information acquiring unit 73 may perform position estimation by using images captured by the cameras in the sensor group 71, and point cloud data of the lidars.

(2e) The position information acquiring unit 73 may detect the markers by using the sensor group 71 while the self-driving vehicle 18 is travelling from the entrance 15 to the entrance car room 3. The markers may be detected on the basis of images captured by a camera included in the self-driving vehicle 18 or may be detected by a lidar. In this case, the position information acquiring unit 73 may estimate the current location of the self-driving vehicle 18 from a positional relationship between the map information about the parking lot 8, and detected markers. The position information acquiring unit 73 may transmit, to the management device 39, a result of an estimation of the current location as position information about the self-driving vehicle 18 (called estimated position information). The position information acquiring unit 73 may estimate the position information also during self-driving of the self-driving vehicle 18 similarly, and transmit the position information to the management device 39.

(2f) The management device 39 may obtain the position information about the self-driving vehicle 18 (called detection position information) on the basis of car-park internal situation information supplied by the infrastructure 41. For example, the infrastructure 41 can obtain the detection position information about the self-driving vehicle 18 by using cameras, radars, and the like.

On the other hand, because the management device 39 receives the estimated position information from the self-driving vehicle 18, the management device 39 can have the estimated position information, and the detection position information about the same self-driving vehicle 18. For example, the estimated position information, and the detection position information are expressed by coordinate values in the area of the parking lot 8.

In this case, the abnormality determination unit 47A may calculate a deviation distance between coordinate values corresponding to the estimated position information, and coordinate values corresponding to the detection position information. If the deviation distance is longer than a predetermined value, the abnormality determination unit 47A assesses that there is an anomaly. If the deviation distance is shorter than the predetermined value, the abnormality determination unit 47A can assess that there is not an anomaly.

The manner of transporting the self-driving vehicle 18 that is assessed, by the abnormality determination unit 47A, as being experiencing an abnormality by using the unmanned carrying vehicle 21 can be configured similar to the embodiment described above.

(2g) The self-driving vehicle 18 uses the position information when performing self-driving. Therefore, if the deviation distance is longer than the predetermined value, the self-driving valet parking functionality of the self-driving vehicle 18 may not be used, but the unmanned carrying vehicle 21 may be used. According to this configuration, it is possible to avoid a circumstance where it becomes difficult for the self-driving vehicle 18 to move in the parking lot 8.

The position information acquiring unit 73 may detect a marker installed inside the entrance car room 3, and acquire estimated position information. The management device 39 may assess whether or not the self-driving vehicle 18 can be parked by using the self-driving valet parking functionality, before the management device 39 receives a parking request signal.

(2e) In one aspect of the present disclosure, a display device for notifying an instruction or information for a user may be installed in the entrance car room 3. The infrastructure 41 may include a camera that captures images inside the entrance car room 3, and a sensor that senses objects inside the entrance car room 3. For example, the camera captures images of the self-driving vehicle 18 when the self-driving vehicle 18 enters the entrance car room 3. For example, the sensor measures the self-driving vehicle 18.

In such a configuration, when the self-driving vehicle 18 enters the entrance car room 3, the management device 39 may calculate the size of the vehicle having entered the entrance car room 3 on the basis of information acquired by the infrastructure 41. The infrastructure 41 may sense the mounting status of a roof carrier, a cycle carrier or another carrier, the vehicle height or the like. Information such as the size, carrier mounting status or vehicle height of a vehicle having entered the entrance car room 3 is called appearance information below. The appearance information may include weight information such as the weight, centroid position or axle weight of the vehicle.

On the basis of the appearance information sensed by the infrastructure 41, the abnormality determination unit 47A assesses whether or not the self-driving vehicle 18 is suited to the size of vehicles supposed for the parking assist system 1 or to the specifications of the parking lot 8. The abnormality determination unit 47A may assess whether the self-driving vehicle 18 is suited to the carrying capacity of the unmanned carrying vehicle 21 or the specifications related to transportation.

If the self-driving vehicle 18 is not suited to the specifications of the parking assist system 1 as a result of the determination by the abnormality determination unit 47A, the management device 39 may notify the user that the self-driving vehicle 18 cannot be parked, by using a display device installed in the entrance car room 3. That is, before the user transmits a parking request signal to the management device 39, the user can recognize that the self-driving vehicle 18 cannot be parked in the parking lot 8. Alternatively, at the time point when the user manipulates the terminal device 43, and specifies the self-driving vehicle 18 of the user, the management device 39 may display that the self-driving vehicle 18 cannot be parked.

If the self-driving vehicle 18 can be parked by using the self-driving valet parking functionality as a result of the determination by the abnormality determination unit 47A, the management device 39 may instruct the user to alight. Alternatively, if the self-driving vehicle 18 can be parked by using the self-driving valet parking functionality, the management device 39 does not have to give a notification at all by using a display device.

(2f) If the abnormality determination unit 47A assesses whether or not the self-driving vehicle 18 is suited to the carrying capacity of the unmanned carrying vehicle 21, the management device 39 may implement the following notification in accordance with a result of the determination. If it is assessed that the self-driving vehicle 18 cannot be parked by using the self-driving valet parking functionality, and also can be parked by using the unmanned carrying vehicle 21, the management device 39 may notify that there is a possibility that the self-driving vehicle 18 is caused to enter by using the unmanned carrying vehicle 21, before the user transmits a parking request signal to the management device 39. In this configuration, because the user is notified in advance that there is a possibility that the self-driving vehicle 18 is caused to enter by using the unmanned carrying vehicle 21, the sense of discomfort felt by the user due to the fact that the self-driving vehicle 18 has been parked by using the unmanned carrying vehicle 21 can be reduced.

In order to realize this configuration, the infrastructure 41 of the parking assist system 1 may measure the self-driving vehicle 18, and the abnormality determination unit 47A may assess whether or not the self-driving vehicle 18 is suited to the parking lot 8 on the basis of a result of the measurement by the infrastructure 41.

(2g) The abnormality determination unit 47A may notify whether or not the self-driving vehicle 18 can be parked, on the basis of a result of the determination as to whether or not the self-driving vehicle 18 is suited to the parking lot 8 before receiving the parking request signal from the user. Furthermore, the abnormality determination unit 47A may notify that the self-driving vehicle 18 cannot be parked in the parking lot 8 on the basis of the result of the determination as to whether or not the self-driving vehicle 18 is suited to the parking lot 8 before receiving the parking request signal. Alternatively, the abnormality determination unit 47A may notify that the self-driving vehicle 18 is transported by the unmanned carrying vehicle 21 on the basis of the result of the determination as to whether or not the self-driving vehicle 18 is suited to the parking lot 8 before receiving the parking request signal.

According to this configuration, on the basis of the measurement result, the management device 39 notifies whether or not the self-driving vehicle 18 can be parked, before receiving the parking request signal. That is, it is possible for the parking assist system 1 to give a notification, before transmission of a parking request signal, that the parking area 7 cannot be used to a user of a vehicle which is too big, a vehicle which is too small, a vehicle whose vehicle height is too tall, a vehicle whose vehicle height is too short or a vehicle on which a carrier or the like which becomes a hindrance at the time of entrance or exit is mounted.

The convenience is enhanced because the user can know that the parking area 7 cannot be used, before the user alights from the self-driving vehicle 18. Because measurement of the vehicle is implemented before transmission of a parking assistance request, the waiting period of the user on the terminal device 43 can be shortened.

(2h) The infrastructure 41 may be cameras and sensors whose detection ranges are areas from the entrance 15 to the entrance car room 3. In this case, the self-driving vehicle 18 is measured while the self-driving vehicle 18 heads to the entrance car room 3 from the entrance 15. If the self-driving vehicle 18 is not suited to the specifications of the parking assist system 1 as a result of the determination by the abnormality determination unit 47A, a display device installed near the entrance of the entrance car room 3 notifies that the self-driving vehicle 18 cannot be parked. According to this configuration, because it can be known that the parking area 7 cannot be used before entering the entrance car room 3, there is not the labor of exiting from the interior of the vehicle.

(2i) According to the configurations of (2c) to (2h) described above, advantageous effects illustrated in (2j-1) to (2j-4) described below can be attained.

(2j-1) In one aspect of the present disclosure, the infrastructure 41 configured to measure values related to the self-driving vehicle 18 (e.g. appearance information, weight information, etc.) is included further, and the abnormality determination unit 47A is configured to assess whether or not the self-driving vehicle 18 is suited to the parking lot 8 on the basis of a result of the measurement by the infrastructure 41.

According to such a configuration, because the result of the measurement by the infrastructure 41 is used, it is possible to assess whether or not the self-driving vehicle 18 is suited to the parking lot 8 without having to use information obtained from the self-driving vehicle 18, and also by using, in combination, information obtained from the self-driving vehicle 18.

(2j-2) The driving settings unit 47B is configured to receive a parking request signal for requesting to transport the self-driving vehicle 18 positioned in the boarding/alighting area to a parking position in accordance with manipulation by the user. The abnormality determination unit 47A is configured to notify whether or not the self-driving vehicle 18 can be parked, on the basis of the result of the determination as to whether or not the self-driving vehicle 18 is suited to the parking lot 8 before receiving the parking request signal.

According to such a configuration, because, before the parking request signal is received, it is notified whether or not the self-driving vehicle 18 can be parked, it is possible to assess earlier whether or not the self-driving vehicle 18 can be parked.

(2j-3) The abnormality determination unit 47A is configured to notify that the self-driving vehicle 18 is transported by the unmanned carrying vehicle 21 on the basis of the result of the determination as to whether or not the self-driving vehicle 18 is suited to the parking lot 8 before receiving the parking request signal.

According to such a configuration, if the self-driving vehicle 18 is parked by using the unmanned carrying vehicle 21 despite the fact that the self-driving vehicle 18 has a functionality of parking by self-driving, a notification to that effect can be given to the user or the like.

(2j-4) The driving settings unit 47B is configured to transmit a transport instruction to the unmanned carrying vehicle 21 independently of a vehicle status if, when the self-driving vehicle 18 moves from the boarding/alighting area to a parking position, the unmanned carrying vehicle 21 transports the self-driving vehicle 18, and thereafter the management device 39 has received an exit request about the self-driving vehicle 18.

According to such a configuration, if the unmanned carrying vehicle 21 is used at the time of entrance, it is possible to perform setting promptly such that the unmanned carrying vehicle 21 is used at the time of exit.

(2k) A plurality of functionalities that one constituent element in the embodiments described above has may be realized by a plurality of constituent elements, one functionality that one constituent element has may be realized by a plurality of constituent elements, and so on. A plurality of functionalities that a plurality of constituent elements have may be realized by one constituent element, one functionality that is realized by a plurality of constituent elements may be realized by one constituent element, and so on. Some of the configurations of the embodiments described above may be omitted. At least some of the configurations of the embodiments described above may be added to or replace the configurations of another embodiment described above.

(2l) Other than the parking assist system 1 mentioned above, the present disclosure can also be realized in various forms such as the management device 39 which serves as a constituent element of the parking assist system 1, a program for causing a computer to function as the management device 39 or the like, a non-transitory tangible recording medium such as a semiconductor memory having the program recorded thereon or a parking assistance method.

What is claimed is:

1. A parking assist system configured to assist for a vehicle to park, the parking assist system comprising:
a self-driving vehicle configured to perform self-driving from a boarding/alighting area to a parking position in a parking lot;
an unmanned carrying vehicle that is configured to transport a vehicle in the parking lot; and
a management device that is configured to move the self-driving vehicle by the unmanned carrying vehicle between the parking position and the boarding/alighting area by controlling the unmanned carrying vehicle and the self-driving vehicle, wherein
the self-driving vehicle includes:
a status transmitting unit that is configured to transmit, to the management device, a vehicle status indicative of a status of the self-driving vehicle; and
a position transmitting unit that is configured to repeatedly transmit position information indicative a position of the self-driving vehicle to the management device, and
the management device includes:
an abnormality determination unit that is configured to determine whether an abnormality occurs in the self-driving vehicle based on the vehicle status when receiving the vehicle status;
a driving settings unit that is configured to:
transmit, to the unmanned carrying vehicle, a transport instruction for the unmanned carrying vehicle to transport the self-driving vehicle when the abnormality determination unit determines that an abnormality occurs; and
transmit, to the self-driving vehicle, an self-driving instruction for the self-driving vehicle to move by self-driving when the abnormality determination unit determines that an abnormality does not occur;
a stop position determination unit that is configured to determine whether the self-driving vehicle stops at a stop position on a path in the parking lot based on the position information transmitted from the self-driving vehicle when the self-driving vehicle is stopped; and
a travel transmitting unit that is configured to, when the stop position determination unit determines that the stop position is on a path in the parking lot:
generate a travel route from a current location of the unmanned carrying vehicle to the stop position of the self-driving vehicle; and
transmit the generated travel route to the unmanned carrying vehicle.

2. The parking assist system according to claim 1, wherein
the status transmitting unit is a first status transmitting unit, and
the self-driving vehicle further includes a second status transmitting unit that is configured to transmit the vehicle status to the management device during self-driving in the parking lot after the self-driving vehicle received the self-driving instruction from the driving settings unit.

3. The parking assist system according to claim 1, wherein
the management device further includes a stop transmitting unit that is configured to transmit a stop command to the self-driving vehicle when an abnormality is determined to occur in the self-driving vehicle.

4. The parking assist system according to claim 1, wherein
the management device further includes a movement transmitting unit that is configured to transmit, to the self-driving vehicle that is parked at a parking position in the parking lot, a movement instruction for the self-driving vehicle to move to another parking position in the parking lot,
the status transmitting unit is a first status transmitting unit, and
the self-driving vehicle further includes a third status transmitting unit that is configured to transmit, to the management device, the vehicle status during self-driving in the parking lot after the self-driving vehicle received the movement instruction from the movement transmitting unit.

5. A parking assist system configured to provide assistance of parking for a vehicle, the parking assist system comprising:
a parking lot including a parking position and a boarding/alighting area;
an unmanned carrying vehicle that is configured to transport a vehicle in the parking lot; and
a management device configured to move a self-driving vehicle by the unmanned carrying vehicle between the parking position and the boarding/alighting area by controlling the unmanned carrying vehicle and a self-driving vehicle, the self-driving vehicle being configured to perform self-driving from the boarding/alighting area to the parking position, wherein
the management device includes:
an abnormality determination unit that is configured to determine whether an abnormality occurs in the self-driving vehicle based on a vehicle status transmitted from the self-driving vehicle when the vehicle status is received, the vehicle status indicating a status of the self-driving vehicle; and
a driving settings unit that is configured to:
transmit, to the unmanned carrying vehicle, a transport instruction for the unmanned carrying vehicle to transport the self-driving vehicle when the abnormality determination unit determines that an abnormality occurs; and
transmit, to the self-driving vehicle, a self-driving instruction for the self-driving vehicle to move by self-driving when the abnormality determination unit determines that an abnormality does not occur, wherein
the driving settings unit is further configured to transmit the transport instruction to the unmanned carrying vehicle irrespective of the vehicle status when the management device receives an exit request for the self-driving vehicle if the self-driving vehicle was transported by the unmanned carrying vehicle from the boarding/alighting area to the parking position.

6. A parking assist system configured to provide assistance of parking for a vehicle, the parking assist system comprising:
a parking lot including a parking position and a boarding/alighting area;
an unmanned carrying vehicle that is configured to transport a vehicle in the parking lot;
a management device configured to move a self-driving vehicle by the unmanned carrying vehicle between the parking position and the boarding/alighting area by controlling the unmanned carrying vehicle and a self-driving vehicle, the self-driving vehicle being configured to perform self-driving from the boarding/alighting area to the parking position; and
an infrastructure that is configured to measure the self-driving vehicle, wherein
the management device includes:
an abnormality determination unit that is configured to determine whether an abnormality occurs in the self-driving vehicle based on a vehicle status transmitted from the self-driving vehicle when the vehicle status is received, the vehicle status indicating a status of the self-driving vehicle; and
a driving settings unit that is configured to:
transmit, to the unmanned carrying vehicle, a transport instruction for the unmanned carrying vehicle to transport the self-driving vehicle when the abnormality determination unit determines that an abnormality occurs; and
transmit, to the self-driving vehicle, a self-driving instruction for the self-driving vehicle to move by self-driving when the abnormality determination unit determines that an abnormality does not occur, and
the abnormality determination unit is further configured to determine whether the self-driving vehicle is compatible to the parking lot based on a result of the measurement by the infrastructure.

7. The parking assist system according to claim 6, wherein
the driving settings unit is configured to receive a parking request signal that causes the unmanned carrying vehicle to transport, to the parking position, the self-driving vehicle positioned in the boarding/alighting area in response to operation by a user, and
the abnormality determination unit is configured to notify, before the driving setting unit receives the parking request signal, the user of whether the self-driving vehicle can be parked based on a determination result of whether the self-driving vehicle is compatible to the parking lot.

8. The parking assist system according to claim 7, wherein
the abnormality determination unit is configured to notify, before the driving setting unit receives the parking request signal, the user that the self-driving vehicle cannot be parked in the parking lot based on the determination result of whether the self-driving vehicle is compatible to the parking lot.

9. The parking assist system according to claim 7, wherein
the abnormality determination unit is configured to notify, before the driving setting unit receives the parking request signal, the user that the self-driving vehicle is to be transported by the unmanned carrying vehicle based on the determination result of whether the self-driving vehicle is compatible to the parking lot.

10. The parking assist system according to claim 6, wherein
the abnormality determination unit is configured to receive a vehicle status indicative of a status of the self-driving vehicle from the self-driving vehicle during self-driving in the parking lot after the self-driving vehicle started self-driving.
